(19) United States
(12) Patent Application Publication
(10) Pub. No.: US 2026/0288413 A1
(43) Pub. Date: Sep. 24, 2026

(54) COMPUTING DEVICE AND COMPUTING METHOD

(71) Applicant: Preferred Networks, Inc., Tokyo (JP)

(72) Inventors: Toru KOIZUMI, Tokyo (JP); Ryota SHIOYA, Tokyo (JP); Takuya YAMAUCHI, Tokyo (JP); Tomoya ADACHI, Tokyo (JP); Ken NAMURA, Tokyo (JP); Junichiro MAKINO, Tokyo (JP)

(21) Appl. No.: 19/570,627

(22) Filed: Mar. 18, 2026

Related U.S. Application Data
(60) Provisional application No. 63/775,435, filed on Mar. 21, 2025.

(30) Foreign Application Priority Data
Jun. 19, 2025 (JP) 2025-103509

(51) Int. Cl. G06F 7/499; G06F 7/483

(52) U.S. Cl. CPC G06F 7/49947; G06F 7/483; G06F 2207/4824

(57) ABSTRACT

A computing device includes one or more computing circuits. The one or more computing circuits are configured to perform an arithmetic operation; predict a section of consecutive trailing ones of a first bit sequence representing an arithmetic result of the arithmetic operation; and round the arithmetic result based on the predicted section of the consecutive trailing ones.

### CROSS-REFERENCE TO RELATED APPLICATIONS

This patent application is based on and claims priority to U.S. Provisional Application No. 63/775,435 filed on Mar. 21, 2025, and Japanese Patent Application No. 2025-103509 filed on Jun. 19, 2025, the entire contents of which are incorporated herein by reference.

### TECHNICAL FIELD

The present disclosure relates to a computing device and a computing method.

### BACKGROUND

A computing circuit configured to compute floating-point fused multiply-add (FMA) operations is known. The floating-point fused multiply-add operation is an arithmetic operation in which a multiplication and an addition are performed in one operation, and rounding is performed after addition.

### RELATED ART DOCUMENT

### Patent Document

[Non-Patent Document 1]S. D. Trong, M. Schmookler, E. M. Schwarz, and M. Kroener, “P6 binary floating-point unit,” in 18th IEEE Symposium on Computer Arithmetic (ARITH'07), 2007, pp. 77-86.

### SUMMARY

A computing device according to one aspect of the present disclosure includes one or more computing circuits. The one or more computing circuits are configured to perform an arithmetic operation; predict a section of consecutive trailing ones of a first bit sequence representing an arithmetic result of the arithmetic operation; and round the arithmetic result based on the predicted section of the consecutive trailing ones.

### BRIEF DESCRIPTION OF THE DRAWINGS

FIG. 1 is a block diagram illustrating an example of a computing device;

FIG. 2 is a block diagram illustrating an example of a computing unit;

FIG. 3 is a diagram illustrating a first example of a prefix box;

FIG. 4 is a diagram illustrating an example of a bit sequence handled by a trailing ones anticipator;

FIG. 5 is a block diagram illustrating an example of the trailing ones anticipator;

FIG. 6 is a diagram illustrating a second example of the prefix box;

FIG. 7 is a diagram illustrating an example of an OR circuit;

FIG. 8 is a diagram illustrating an example of a bitonic sort circuit;

FIG. 9 is a flowchart illustrating an example of a computing method;

FIG. 10 is a graph illustrating an example of evaluation results; and

FIG. 11 is a block diagram illustrating an example of a hardware configuration of a computer.

### DETAILED DESCRIPTION

Hereinafter, embodiments of the present disclosure will be described with reference to the accompanying drawings. Here, in the present specification and the drawings, components having substantially the same functional configuration are denoted by the same reference numerals, and duplicated descriptions thereof will be omitted.

A first embodiment of the present disclosure may be an example of a computing device configured to perform a predetermined operation. The computing device may include any computing unit configured to perform a selected operation. The computing device may perform operations in various fields, such as scientific computing, chemical computing, machine learning, or image processing, for example.

The computing device may function as an accelerator configured to perform operations related to a machine learning model, for example. The operations related to the machine learning model may include, for example, operations for performing a training process and operations for performing an inference process. The machine learning model may include, for example, a neural network, a generative model, a foundation model, a large language model (LLM), a space state model (SSM), and the like.

The computing device may be connected to another processor. The other processor may include a central processing unit (CPU) or a graphics processing unit (GPU). The computing device may function as a computer configured to perform a selected operation.

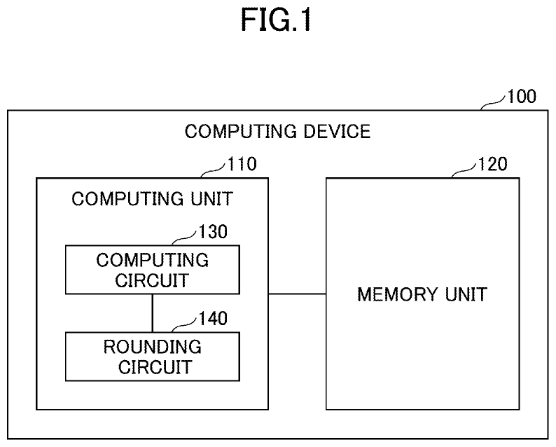

The computing device according to the present embodiment will be described with reference to FIG. 1. FIG. 1 is a block diagram illustrating an example of the computing device.

As illustrated in FIG. 1, a computing device 100 may include a computing unit 110 and a memory unit 120. The computing unit 110 may include a computing circuit 130 and a rounding circuit 140.

Although FIG. 1 illustrates, for example, the computing device 100 including one combination of the computing unit 110 and the memory unit 120, the number of these combinations may be suitably configured. That is, the computing device 100 may include two or more combinations of the computing unit 110 and the memory unit 120. Additionally, the number of computing units 110 and the number of memory units 120 in one combination may also be suitably configured, and the number of computing units 110 in one combination may be greater than the number of memory units 120, or the number of memory units 120 in one combination may be greater than the number of computing units 110. The computing unit 110 and the memory unit 120 may be connected via a data transfer circuit such as a direct memory access (DMA) controller, for example. When the computing device 100 includes two or more combinations of the computing unit 110 and the memory unit 120, one computing unit 110 may be connected to a plurality of memory units 120 such that data communication can be performed, or a plurality of computing units 110 may be connected to a single memory unit 120 such that data communication can be performed, via one or more data transfer circuits.

The computing unit 110 may be an example of an arithmetic unit. The computing device 100 may include one or more other arithmetic units different from the computing unit 110. The other arithmetic units may perform the same or different operations as the computing unit 110. The other arithmetic units may be connected to the same data transfer circuit as the computing unit 110.

The computing unit 110 may, for example, perform a predetermined operation in accordance with an instruction issued by a host CPU connected to the computing device 100. The instruction issued by the host CPU may be included in a program generated by a compiler device. The instruction issued by the host CPU may include a Single Instruction/Multiple Data (SIMD) instruction. The SIMD instruction may be an instruction set for processing a plurality of data in parallel by a single instruction.

The memory unit 120 may be an example of a storage device configured to store data. The memory unit 120 may store data used by the computing unit 110 for computation. The memory unit 120 may store data including an arithmetic result obtained by the computing unit 110.

The memory unit 120 may store data related to a machine learning model for example. The data related to the machine learning model may include, for example, parameters of the machine learning model. The parameters of the machine learning model may include, for example, parameters of a neural network, a transformer, a state-space model, or the like. The data related to the machine learning model may include intermediate data of the machine learning model, as another example. The intermediate data of the machine learning model may include, for example, a key value cache of a transformer, state information of a state-space model, or the like.

The memory unit 120 may include, for example, a dynamic random access memory (DRAM), a static random access memory (SRAM), a magnetoresistive random access memory (MRAM), a phase-change random access memory (PRAM), a flash memory, or the like, and a hierarchical structure may be formed by selecting any memories among these memories. The memory unit 120 may include one or more DRAMs, one or more SRAMs, one or more MRAMs, one or more PRAMs, one or more flash memories, and the like. The memory unit 120 may be, for example, a semiconductor memory having a three-dimensional stacked structure. The memory unit 120 may be, for example, a semiconductor memory conforming to the HBM standard (for example, HBM3E).

The computing circuit 130 may be an example of a processing circuit configured to perform a predetermined operation. The computing circuit 130 may perform an operation subject to rounding (or fractional part processing). The computing circuit 130 may perform a floating-point calculation, for example. The computing circuit 130 may perform at least one of an addition, a multiplication, or a multiply-add operation, for example. The computing circuit 130 may output an arithmetic result before rounding.

The rounding circuit 140 may be an example of a processing circuit configured to perform rounding. The rounding circuit 140 may perform rounding on the arithmetic result obtained by the computing circuit 130. The rounding circuit 140 may perform rounding on the arithmetic result output from the computing circuit 130 before rounding. The rounding circuit 140 may perform rounding on the result of a floating-point calculation, for example. The rounding circuit 140 may perform rounding on at least one arithmetic result of an addition, a multiplication, or a multiply-add operation, for example.

The rounding circuit 140 may input, to the computing unit 110 or another arithmetic unit, the arithmetic result obtained by rounding. The rounding circuit 140 may output, as an arithmetic result of the computing unit 110, the arithmetic result obtained by rounding.

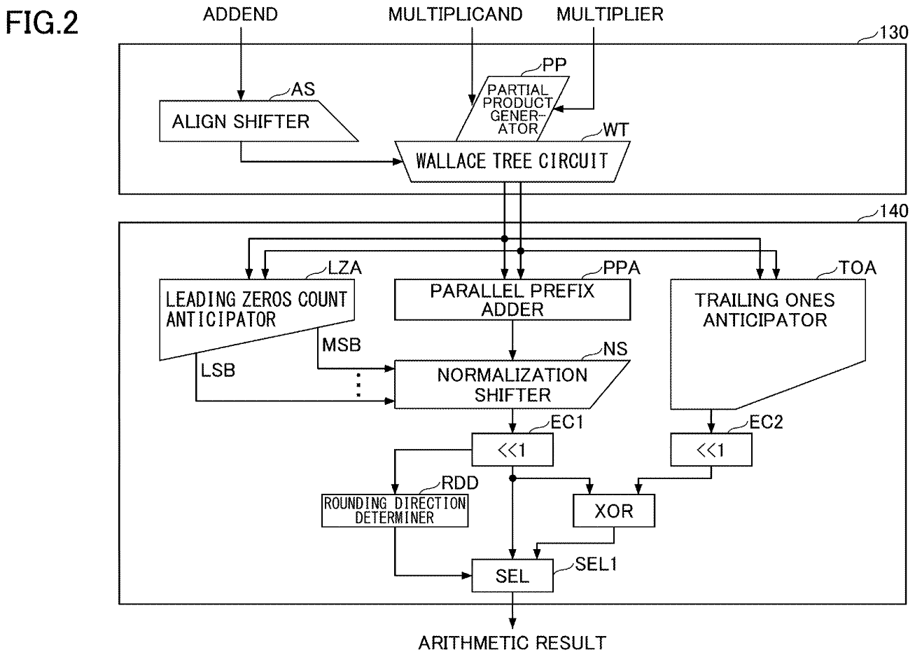

FIG. 2 is a block diagram illustrating an example of the computing unit 110. FIG. 2 illustrates, for example, a schematic configuration of the computing unit 110 configured to perform a floating-point fused multiply-add operation. In the floating-point fused multiply-add operation, the calculation of the mantissa is included in the critical path of the execution time. In the following, the calculation of the mantissa in the floating-point fused multiply-add operation will be described, for example.

As illustrated in FIG. 2, a multiplicand, a multiplier, and an addend may be input to the computing circuit 130. For example, the computing circuit 130 may compute α×β+γ where α is the multiplicand, β is the multiplier, and γ is the addend. Here, α, β, and γ may be floating-point numbers. The floating-point number may be a single-precision floating-point number, a double-precision floating-point number, an extended double-precision floating-point number, a half-precision floating-point number, a quadruple-precision floating-point number, or FP8 (E5M2 or E4M3).

The computing circuit 130 may input an arithmetic result (for example, α×β+γ) before rounding to the rounding circuit 140. The rounding circuit 140 may perform rounding on the input arithmetic result. The rounding circuit 140 may output the arithmetic result obtained by performing rounding, as an arithmetic result of a floating-point fused multiply-add operation.

The computing circuit 130 may include a partial product generator PP, an align shifter AS, and a Wallace tree circuit WT. Additionally, the rounding circuit 140 may include a parallel prefix adder PPA, a leading zeros count anticipator LZA, a trailing ones anticipator TOA, a normalization shifter NS, an error corrector EC1, an error corrector EC2, a rounding direction determiner RDD, an exclusive OR (XOR) circuit XOR, and a selector circuit SELL.

The partial product generator PP may be a computing circuit configured to compute a partial product of a multiplicand and a multiplier. The partial product generator PP may compute a plurality of partial products corresponding to each digit of the multiplicand. The partial product generator PP may be configured by radix-4 Booth encoding, for example. Here, the partial product generator PP may be configured by Booth encoding of a radix of 5 or greater (for example, radix-8 or radix-16). The partial product generator PP may compute the partial product on the premise that the multiplicand and the multiplier are normalized. The partial product generator PP may be configured to normalize the multiplicand and the multiplier only when the multiplicand and the multiplier are not normalized.

The partial product generator PP may output the partial product obtained by computation. The partial product output from the partial product generator PP may be input to the Wallace tree circuit WT.

The align shifter AS may be a computing circuit configured to perform digit alignment of the addend. The align shifter AS may shift the addend to the right so that the partial product calculated by the partial product generator PP matches the exponent. The align shifter AS may perform a right shift operation on the bits from the least significant bit (LSB) to the most significant bit (MSB) in sequence, or may perform a left shift operation on the bits from the MSB to the LSB in sequence.

The align shifter AS may output the shifted addend. The addend output from the align shifter AS may be input to the Wallace tree circuit WT.

The Wallace tree circuit WT may be a computing circuit configured to combine the partial product and the addend. The Wallace tree circuit WT may combine the partial product computed by the partial product generator PP and the addend shifted by the align shifter AS. The Wallace tree circuit WT may add the sum of a plurality of partial products corresponding to the digits of the multiplicand and the addend. The Wallace tree circuit WT may be configured by a plurality of carry save adders (CSA). The Wallace tree circuit WT may add the addend shifted by the align shifter AS to the partial sum of the plurality of partial products computed by the partial product generator PP.

The Wallace tree circuit WT may output two bit sequences representing the arithmetic result of the floating-point fused multiply-add operation. The two bit sequences output from the Wallace tree circuit WT may be input to the rounding circuit 140.

Here, an example in which the computing circuit 130 performs the floating-point fused multiply-add operation by the Wallace tree circuit WT will be described. The computing circuit 130 may be configured by another network structure, for example, a Dadda tree, a hybrid of a Wallace tree and a Dadda tree, a compressor tree, or a CSA tree. The network structure of the computing circuit 130 may be suitably selected, for example, in accordance with a delay time, a wiring length, a circuit area, and the like.

The parallel prefix adder PPA may be a computing circuit configured to sum the two bit sequences output from the Wallace tree circuit WT, for example. The parallel prefix adder PPA may compute the sum of the two bit sequences while processing carry propagation in parallel using a tree structure. The parallel prefix adder PPA may be a simple parallel prefix adder or a parallel prefix dual adder. The parallel prefix dual adder may be a computing circuit combining two parallel prefix adders.

A simple parallel prefix adder may generate a propagation signal P and a generation signal G. The propagation signal P may be defined by Equation (1). The generation signal G may be defined by Equation (2).

$${P}_{i : j} = {∧}_{k = j}^{i - 1} {a}_{k} \underline{∨} {b}_{k} \qquad ( 1 )$$

$${G}_{i : j} = {∨}_{k = j}^{i - 1} {P}_{i - 1 : k + 1} ∧ {a}_{k} ∧ {b}_{k} \qquad ( 2 )$$

Here, a and b are the two bit sequences output from the Wallace tree circuit WT. P_{i:j} indicates that carry generated in the j-th digit propagates to the i-th digit. Additionally, G_{i:j} indicates that whether carry has occurred in the i-th digit can be determined based on the j-th digit to the (i−1)-th digit.

Equations (3) and (4) hold for any k satisfying i>k>j. According to Equations (3) and (4), the circuit area can be optimized by extracting the common part from the calculation process of G_{i:0} (where 0<i<N, N is the bit length of the mantissa).

$${P}_{i : j} = {P}_{i : k} ∧ {P}_{k : j} \qquad ( 3 )$$

$${G}_{i : j} = {G}_{i : k} ∨ ( {P}_{i : k} ∧ {G}_{k : j} ) \qquad ( 4 )$$

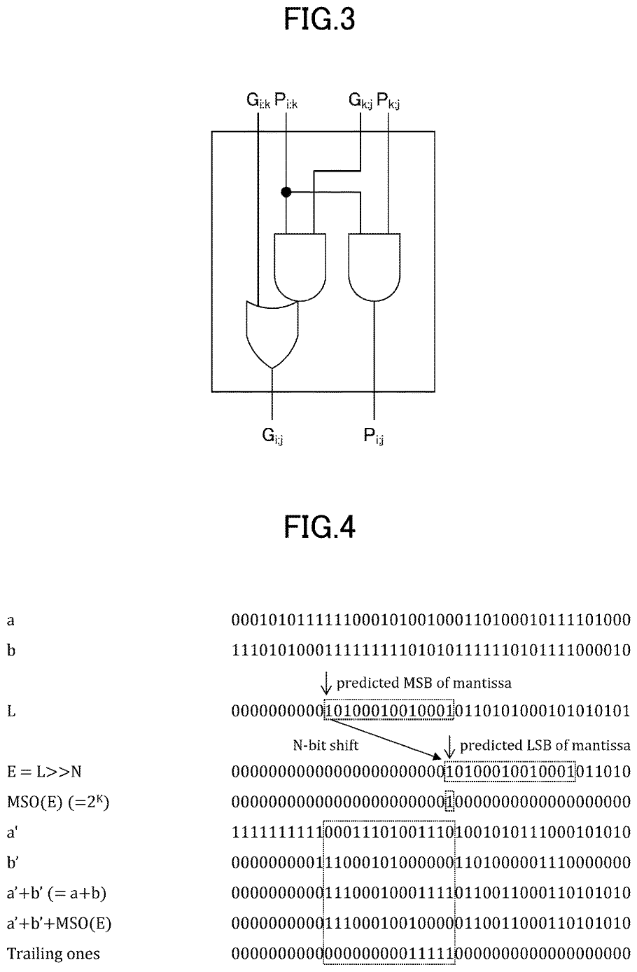

A circuit implementing Equations (3) and (4) is called a prefix box. FIG. 3 illustrates a first example of the prefix box. FIG. 3 illustrates a circuit configuration of a prefix box in the parallel prefix adder PPA. The parallel prefix adder PPA may include a log₂N-stage prefix box.

The parallel prefix double adder may be an adder configured to compute, for example, A+B and A+B+1 simultaneously, using an end-around carry. The parallel prefix double adder may compute P_{1:0} (0<i<N) in addition to G_{1:0} to achieve simultaneous computation of A+B and A+B+1, for example. With this, the parallel prefix double adder can compute a negative result in two's complement form. The circuits required for computing A+B and A+B+1 are largely shared, and thus the parallel prefix double adder can minimize the increase in circuit area.

When a simple parallel prefix adder is used as the parallel prefix adder PPA, instead of computing the two's complement, the parallel prefix adder PPA may compute a one's complement using a rounding incrementer, instead of computing a two's complement. The increment generated by rounding and the increment for computing the two's complement occur mutually exclusively. Therefore, with the configuration described above, even a simple parallel prefix adder can compute the sum of two bit sequences at high speed.

The parallel prefix adder PPA may output a bit sequence of an absolute value obtained by summing the two bit sequences. The bit sequence of the absolute value output from the parallel prefix adder PPA may be input to the normalization shifter NS.

The leading zeros count anticipator LZA may be a computing circuit configured to predict the position of the most significant bit in the sum of the two bit sequences. The leading zeros count anticipator LZA may predict the position of the most significant bit by predicting the number of leading zeros in the sum of the two bit sequences. The leading zeros count anticipator LZA may predict the position of the most significant bit in the sum of the two bit sequences without adding the two bit sequences. The leading zeros count anticipator LZA may predict the position of the most significant bit such that the error is at most one bit.

The leading zeros count anticipator LZA may use, for example, an absolute leading zeros count anticipator configured to predict the number of leading zeros in |a+b+1|. Here, |⋅| is the absolute value of the value. The absolute leading zeros count anticipator may include two components ⋅. A first component may be a circuit configured to compute a prediction value L of |a+b+1|. A second component may be a circuit configured to determine the number of leading zeros in the prediction value L.

The circuit configured to compute the prediction value L may output a bit sequence satisfying the following conditions (1) to (3). (1) The leading part of L of |a+b+1| is 0. (2) The most significant digit where 1 appears in |a+b+1| is 1. (3) The digits below it are arbitrary values. With this, the leading zeros count anticipator LZA can limit the error to at most one bit. For example, the prediction value L may be calculated as L=((HC>>1) AND Z AND (ZC<<1)) OR ((HC>>1) AND G AND (GC<<1)) OR ((H>>1) AND G AND (ZC<<1)) OR ((H>>1) AND Z AND (GC<<1)) OR 1, using H, HC, Z, ZC, ZC, G, GC, where H=a XOR b, HC=NOT H, Z=(NOT a) AND (NOT b), ZC=NOT Z, G=a AND b, GC=NOT G. >>represents a right shift that fills the upper-order bits of the result with the value of the most significant bit before the shift.

The leading zeros count anticipator LZA may output a prediction result of the most significant bit position. The prediction result of the most significant bit position may include information indicating the number of leading zeros. The prediction result output from the leading zeros count anticipator LZA may be input to the normalization shifter NS.

The normalization shifter NS may be a computing circuit configured to normalize the bit sequence of the absolute value. The normalization shifter NS may normalize the bit sequence computed by the parallel prefix adder PPA. The normalization shifter NS may shift the bit sequence of the absolute value to the left using the number of leading zeros predicted by the leading zeros count anticipator LZA as the shift amount. The normalization shifter NS may sequentially shift the bit sequence of the absolute value from the most significant bit according to each bit of the shift amount. The normalization shifter NS may include a log₂(3N+O (1)) stage 2:1 selector. With this, the normalization shifter NS can optimize the delay time and the circuit area. Additionally, the normalization shifter NS may include a barrel shifter.

The normalization shifter NS may output the normalized bit sequence of the absolute value. The bit sequence output from the normalization shifter NS may be input to the error corrector EC1.

The error corrector EC1 may be a computing circuit configured to correct a prediction error by the leading zeros count anticipator LZA. The error corrector EC1 may correct a prediction error in the bit sequence output from the normalization shifter NS. When the first bit of the bit sequence output from the normalization shifter NS is zero, the error corrector EC1 may further shift one bit to the left.

The trailing ones anticipator TOA may be a computing circuit configured to predict a section of consecutive trailing ones in the sum of the two bit sequences. Hereinafter, the section of consecutive trailing ones is referred to as a “trailing-ones section”. The trailing ones anticipator TOA may predict a trailing-ones section in the sum of the two bit sequences without adding the two bit sequence. The trailing ones anticipator TOA may predict a trailing-ones section such that the error is at most one bit.

The trailing ones anticipator TOA may compute a+b and a+b+2^{K}, where a and b are the two bit sequences output from the Wallace tree circuit WT. 2^{K} may be a power of 2 indicating the least significant bit of the mantissa after shifting to the right by the number of bits representable as an effective part of the mantissa based on the number of leading zeros predicted by the leading zeros count anticipator LZA. The trailing ones anticipator TOA may directly compute 2^{K} without explicitly computing K or 2^{K}. The trailing ones anticipator TOA may compute the XOR of a+b and a+b+2^{K}. The trailing ones anticipator TOA may normalize the result of the XOR. The trailing ones anticipator TOA may output the result of the XOR after normalization as the prediction result in the trailing-ones section.

Here, the circuit configured to compute a+b and a+b+2^{K} in the trailing ones anticipator TOA is different from the parallel prefix double adder described above. Although the parallel prefix double adder can simultaneously compute a+b and a+b+2°, it can only add 1 to the numerical value before the shift. Therefore, the parallel prefix double adder cannot compute a+b+2^{K}, which is obtained by adding 1 to the numerical value after the shift.

The trailing ones anticipator TOA may output the prediction result of the trailing-ones section. The prediction result of the trailing-ones section may be a bit sequence in which 1 is set inside the section and 0 is set outside the section. The prediction result of the trailing-ones section output from the trailing ones anticipator TOA may be input to the error corrector EC2.

The error corrector EC2 may be a computing circuit configured to correct a prediction error by the trailing ones anticipator TOA. The error corrector EC2 may correct the prediction error in the bit sequence output from the trailing ones anticipator TOA. When the first bit of the bit sequence output from the normalization shifter NS is zero, the error corrector EC2 may further shift one bit to the left.

The rounding direction determiner RDD may be a computing circuit configured to determine a rounding direction. The rounding direction determiner RDD may determine the rounding direction based on the bit sequence output from the error corrector EC1. The rounding direction determiner RDD may determine whether to perform rounding toward zero or rounding away from zero based on a low-order bit of the bit sequence output from the error corrector EC1.

The rounding direction determiner RDD may output information indicating the determined rounding direction. The information indicating the rounding direction output from the rounding direction determiner RDD may be input to the selector circuit SELL.

The XOR circuit XOR may be a computing circuit configured to compute the XOR of two bit sequences. The XOR circuit XOR may compute the XOR of the bit sequence output from the normalization shifter NS and the bit sequence output from the trailing ones anticipator TOA. The bit sequence output from the normalization shifter NS may be the bit sequence corrected by the error corrector EC. The bit sequence output from the trailing ones anticipator TOA may be the bit sequence corrected by the error corrector EC2.

The XOR circuit XOR may output the bit sequence obtained by the XOR. The bit sequence output from the XOR circuit XOR may be input to the selector circuit SELL.

The selector circuit SEL1 may be a computing circuit configured to select one output from a plurality of inputs. The input of the selector circuit SEL1 may include the bit sequence output from the normalization shifter NS and the bit sequence output from the XOR circuit XOR. The bit sequence output from the normalization shifter NS may be the bit sequence corrected by the error corrector EC1. The bit sequence output from the trailing ones anticipator TOA may be the bit sequence corrected by the error corrector EC2.

The selector circuit SEL1 may select the bit sequence output from the normalization shifter NS or the bit sequence output from the XOR circuit XOR based on the information indicating the rounding direction output from the rounding direction determiner RDD. When the rounding direction indicates rounding away from zero, the selector circuit SEL1 may select the bit sequence output from the XOR circuit XOR. When the rounding direction indicates rounding toward zero, the selector circuit SEL1 may select the bit sequence output from the normalization shifter NS.

The rounding circuit 140 may output the bit sequence selected by the selector circuit SELL. The computing unit 110 may output the bit sequence output from the rounding circuit 140 as an arithmetic result of the predetermined operation performed by the computing circuit 130.

A detailed configuration of the trailing ones anticipator TOA will be described below. Prior to the description, a specific example of the bit sequence handled by the trailing ones anticipator TOA will be described with reference to FIG. 4. FIG. 4 is a diagram illustrating an example of the bit sequence handled by the trailing-ones anticipator.

As illustrated in FIG. 4, the two bit sequences a and b may be input to the trailing ones anticipator TOA. The bit sequences a and b may be bit sequences indicating the arithmetic result of the predetermined operation performed by the computing circuit 130. The bit sequences a and b may be the two bit sequences output from the Wallace tree circuit WT of the computing circuit 130.

The trailing ones anticipator TOA may compute the prediction value L of the sum of the two bit sequences a and b. The trailing ones anticipator TOA may predict the position of the most significant bit of the mantissa in the prediction value L. The trailing ones anticipator TOA may compute an estimation value E by shifting the prediction value L to the right by N bits. Here, the power of 2 (2^{K}) indicating the least significant bit of the mantissa may be calculated based on the estimation value E. Additionally, N may be the bit length of the mantissa. The trailing ones anticipator TOA may compute a bit sequence MSO(E) by masking the bits lower than the most significant bit of the estimation value E with zeros.

The trailing ones anticipator TOA may convert the bit sequences a and b into bit sequences a′ and b′, respectively. This conversion may be, for example, a′=a XOR b and b′=(a AND b)<<1. Here, the bit sequences a′ and b′ are bit sequences such that a′+b′=a+b. The trailing ones anticipator TOA may compute the sum (a′+b′) of the bit sequence a′ and the bit sequence b′. The trailing ones anticipator TOA may compute the sum (a′+b′+MSO(E)) of the bit sequence a′, the bit sequence b,′ and the bit sequence MSO(E). The trailing ones anticipator TOA may compute the XOR of a′+b′ and a′+b′+MSO(E). As illustrated in FIG. 4, the result of the XOR is, in the arithmetic result of a+b, a bit sequence in which the section of consecutive trailing ones of the mantissa, which is the arithmetic result, is set to 1 and the other section is set to 0.

Here, the bit sequences a and b are examples of the bit sequences indicating the arithmetic result. The XOR of a′+b′ and a′+b′+MSO(E) is an example of a second bit sequence. MSO(E) is an example of a third bit sequence.

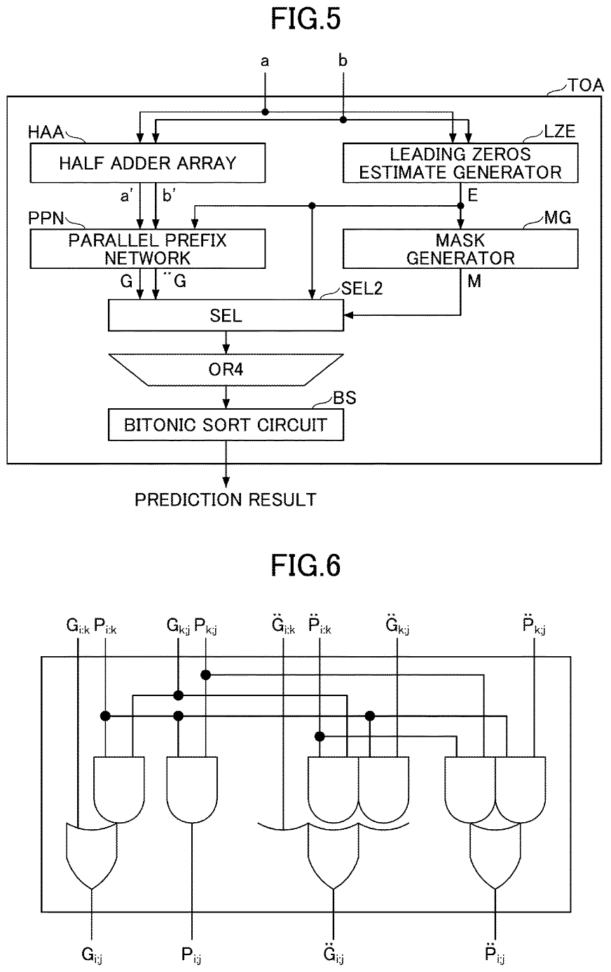

FIG. 5 is a block diagram illustrating an example of the trailing ones anticipator. As illustrated in FIG. 5, the two bit sequences a and b may be input to the trailing ones anticipator TOA. The bit sequences a and b may be the two bit sequences output from the Wallace tree circuit WT of the computing circuit 130. The trailing ones anticipator TOA may predict the trailing-ones section in the sum of the bit sequences a and b based on the input bit sequences a and b. The trailing ones anticipator TOA may output the prediction result of the trailing-ones section.

The trailing ones anticipator TOA may include a leading zeros estimate generator LZE, a half adder array HAA, a parallel prefix network PPN, a mask generator MG, a selector circuit SEL2, an OR circuit OR4, and a bitonic sort circuit BS.

The leading zeros estimate generator LZE may be a computing circuit configured to compute the estimation value E of the power of 2 (2^{K}) indicating the least significant bit of the mantissa. The leading zeros estimate generator LZE may compute the estimation value E using the prediction value L output from the leading zeros count anticipator LZA. The leading zeros estimate generator LZE may compute the estimation value E by shifting the prediction value L to the right by N bits.

The leading zeros estimate generator LZE may output the estimation value E obtained by the computation. The estimation value E output from the leading zeros estimate generator LZE may be input to the parallel prefix network PPN and the mask generator MG.

The half adder array HAA may be a computing circuit configured to convert the bit sequences a and b into the bit sequences a′ and b′. The half adder array HAA may compute the bit sequences a′ and b′ based on the bit sequences a and b such that a′+b′=a+b is satisfied. The half adder array HAA may compute the bit sequences a′ and b′ such that the inequality of Equation (5) is satisfied.

$${\sum }_{k = 0}^{i} {2}^{k} ( {a}_{k}^{′} + {b}_{k}^{′} ) < 3 \cdot {2}^{i} \qquad ( 5 )$$

By computing the bit sequences a′ and b′ to satisfy the equation (5), the carry from every digit is at most 1 when computing a′+b′+MSO(E). This point guarantees that the inequality of the equation (6) holds.

$${\sum }_{k = 0}^{i} {2}^{k} ( {a}_{k}^{′} + {b}_{k}^{′} + {MSO ( E )}_{k} ) < 4 \cdot {2}^{i} \qquad ( 6 )$$

The half adder array HAA may output the bit sequences a′ and b′. The bit sequences a′ and b′ output from the half adder array HAA may be input to the parallel prefix network PPN.

The parallel prefix network PPN may be a computing circuit configured to generate two generation signals G and \ddot{ }G. The parallel prefix network PPN may generate the two generation signals G and \ddot{ }G based on the two bit sequences a′ and b′ output from the half adder array HAA and the estimation value E output from the leading zeros estimate generator LZE.

Here, the symbol “\ddot{ }” is a symbol (umlaut) to be written directly above the immediately following character, but it is written immediately before the character in the text due to the limitation of text notation. Hereinafter, the symbol is written immediately above the original character in mathematical expressions.

Similar to the parallel prefix adder PPA, the parallel prefix network PPN may generate the propagation signal P and the generation signal G defined by Equations (1) to (2). In addition to the propagation signal P and the generation signal G, the parallel prefix network PPN may generate a propagation signal \ddot{ }P and a generation signal \ddot{ }G defined by Equations (7) to (10).

$${\ddot{P}}_{i + 1 : i} = {a}_{i} \underline{∨} {b}_{i} \underline{∨} {E}_{i} \qquad ( 7 )$$

$${\ddot{G}}_{i + 1 : i} = ( {a}_{i} ∧ {b}_{i} ) ∨ ( {b}_{i} ∧ {E}_{i} ) ∨ ( {E}_{i} ∧ {a}_{i} ) \qquad ( 8 )$$

$${\ddot{P}}_{i : j} = ( {\ddot{P}}_{i : k} ∧ {P}_{k : j} ) ∨ ( {P}_{i : k} ∧ {\ddot{P}}_{k : j} ) \qquad ( 9 )$$

$${\ddot{G}}_{i : j} = {\ddot{G}}_{i : k} ∨ ( {\ddot{P}}_{i : k} ∧ {G}_{k : j} ) ∨ ( {P}_{i : k} ∧ {\ddot{G}}_{k : j} ) \qquad ( 10 )$$

\ddot{ }G_{i:j} indicates a generation signal when p_{MSO}(E) is between bit positions i−1 and j. Similarly, \ddot{ }P_{i:j} indicates a propagation signal when p_{MSO}(E) is between bit positions i−1 and j. Here, p_{MSO}(⋅) represents the position of the most significant bit of the value.

The parallel prefix network PPN may include a prefix box implementing Equations (7) to (10). FIG. 6 is a diagram illustrating a second example of the prefix box. FIG. 6 illustrates a circuit configuration of the prefix box in the parallel prefix network PPN.

The parallel prefix network PPN may output the generation signals G and \ddot{ }G. The generation signals G and \ddot{ }G output from the parallel prefix network PPN may be input to the selector circuit SEL2.

The mask generator MG may be a computing circuit configured to generate a mask M for the input bit sequence. The mask generator MG may generate the mask M for the estimation value E output from the leading zeros estimate generator LZE. The mask M may be a mask that sets the bits lower than the most significant bit of the estimation value E to zero. For example, the mask generator MG may generate the mask M by the following procedure.

$$M = E >> 1 ;$$

$$for shamt in \{ 1 , 2 , 4 , 8 , 16 , … \} :$$

$$M \vert = M >> shamt ;$$

The selector circuit SEL2 may be a computing circuit configured to receive a plurality of bit sequences as inputs and select one output bit for each bit. The inputs of the selector circuit SEL2 may include two generation signals G and \ddot{ }G output from the parallel prefix network PPN. The selector circuit SEL2 may select an output bit from one of the two generation signals G and \ddot{ }G based on the mask M output from the mask generator MG.

For example, the selector circuit SEL2 may select the generation signal G for the bits higher than the most significant bit of the estimation value E and select the generation signal \ddot{ }G for the bits lower than the most significant bit of the estimation value E. The selector circuit SEL2 may generate the generation signal G^{e} defined by (G&M)|(\ddot{ }G&\tilde{ }M). Here, “&” represents a logical AND and “\tilde{ }” represents negation.

The selector circuit SEL2 may compute the XOR of the two bit sequences. The selector circuit SEL2 may compute the XOR of a′+b′ and a′+b′+MSO(E). a′+b′ may be expressed as a′(+)b′(+)(G<<1). a′+b′+MSO(E) may be expressed as a′(+)b′(+)MSO(E)(+)(G^{e}<<1). Here, (+) represents the XOR. MSO(E) may be defined by E&\tilde{ }M. Accordingly, the selector circuit SEL2 may compute (E&\tilde{ }M)|(((G\hat{ }\ddot{ }G)&\tilde{ }M)<<1). With this, the selector circuit SEL2 may predict the trailing-ones section. Here, the selector circuit SEL2 may predict the trailing-ones section without explicitly computing the value of a+b+2^{K}.

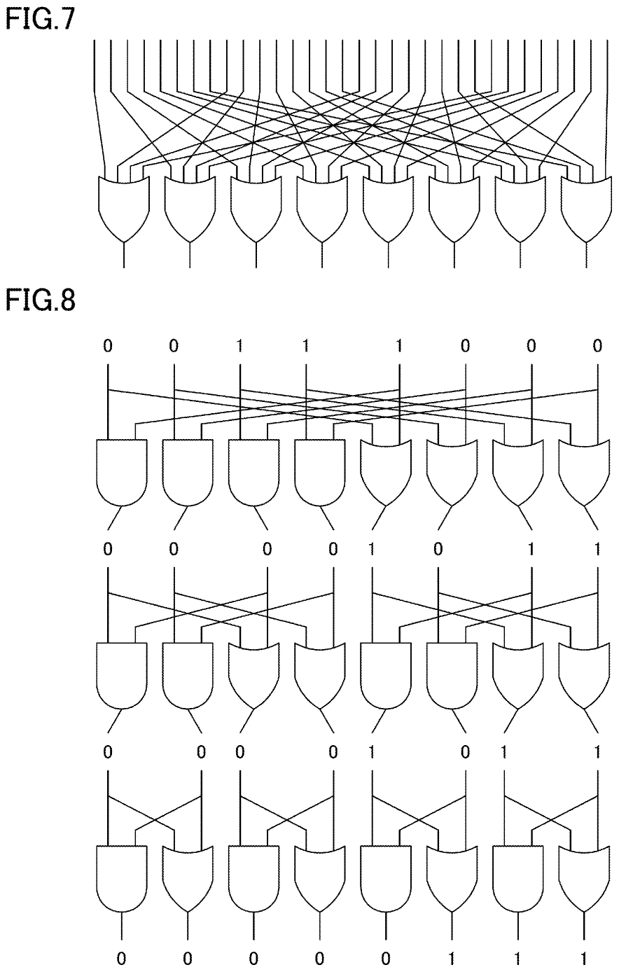

FIG. 7 is a diagram illustrating an example of the OR circuit OR4. The OR circuit OR4 may be a computing circuit configured to compute the OR of the input bit sequences. The OR circuit OR4 may divide the output of the selector circuit SEL2 into four parts. As illustrated in FIG. 7, the OR circuit OR4 may compute the OR in units of four bits by using the output of the selector circuit SEL2 that is divided into four parts. The OR circuit OR4 may output a computation result of the OR. The computation result output from the OR circuit OR4 may be input to the bitonic sort circuit BS.

FIG. 8 illustrates an example of the bitonic sort circuit BS. As illustrated in FIG. 8, the bitonic sort circuit BS may be a computing circuit configured to normalize the input bit sequence by shifting, to the right, ones in the input bit sequence toward the end. The bitonic sort circuit BS may normalize the prediction result in the trailing-ones section output from the selector circuit SEL2. The bitonic sort circuit BS may normalize the prediction result in the trailing-ones section based on the bit sequence output from the OR circuit OR4.

The bitonic sort circuit BS may normalize the prediction result by the bitonic sort. The output of the selector circuit SEL2 is a bitonic string, and thus the prediction result can be normalized by the bitonic sort. The bitonic sort is a parallel sorting algorithm capable of highly efficient normalization shifting. A bitonic sequence may be defined as numerical values that can be expressed by the regular expression 0*1*0*. Such a bitonic sequence can be shifted to the right by Θ(log N) steps by performing a bitonic sort. The trailing ones start from the least significant bit by its nature, and thus the sort is functionally equivalent to a normalization shift. Therefore, a normalization shift of general numerical values may be replaced by a bitonic sort.

The bitonic sort circuit BS may reduce the circuit width as follows. The bitonic sort circuit BS may sort inputs that can be expressed by the regular expression 1*0*1* or 0*1*0*. Furthermore, the bitonic sort circuit BS may sort computation results of the bitwise OR by the OR circuit OR4. The input of 4N+O(1) bits include no more than N+1 bits set to 1, and thus the same result can be obtained by sorting the calculation result by the OR circuit OR4.

The trailing ones anticipator TOA illustrated in FIG. 5 includes the parallel prefix network PPN including a complicated prefix box, and thus the delay time may become large. With respect to the above, the trailing ones anticipator TOA uses the bitonic sort circuit BS to perform a normalization shift based on a lightweight bitonic sort, and thus the trailing-ones section can be predicted at high speed. As a result, the trailing ones anticipator TOA is configured to reduce the delay time of the entire circuit by including the bitonic sort circuit BS.

The trailing ones anticipator TOA may modify the prediction result of the trailing-ones section. As a possible cause for inaccurate prediction, for example, there is a possibility that the prediction value L of the leading zeros count anticipator LZA includes an error of at most one bit. The prediction value L including an error of one bit indicates that the trailing one is predicted from the second digit from the tail in the mantissa before rounding. This problem can be addressed by classifying the cases according to whether the mantissa before rounding is even or odd (in other words, whether the last digit is 0 or 1) as follows.

If the last digit of the mantissa before rounding is zero, the addition of one may be realized by changing the bit of the last digit to one. In this case, the predicted trailing one is not used. When the last digit of the mantissa before rounding is 1, the addition of one may be realized by setting the bit of the last digit to 0, shifting the predicted trailing ones by one bit to the left, and performing the XOR on the other parts.

When a+b is negative, only calculating a+b+MSO(E) may be insufficient for computing the trailing ones. In this case, −a−b+MSO(E) may be computed together. For example, the trailing ones anticipator TOA may include a circuit configured to compute \tilde{ }a\tilde{ }b+MSO(E) in addition to the circuit configured to compute a+b+MSO(E).

### <Flow of Computing Method>

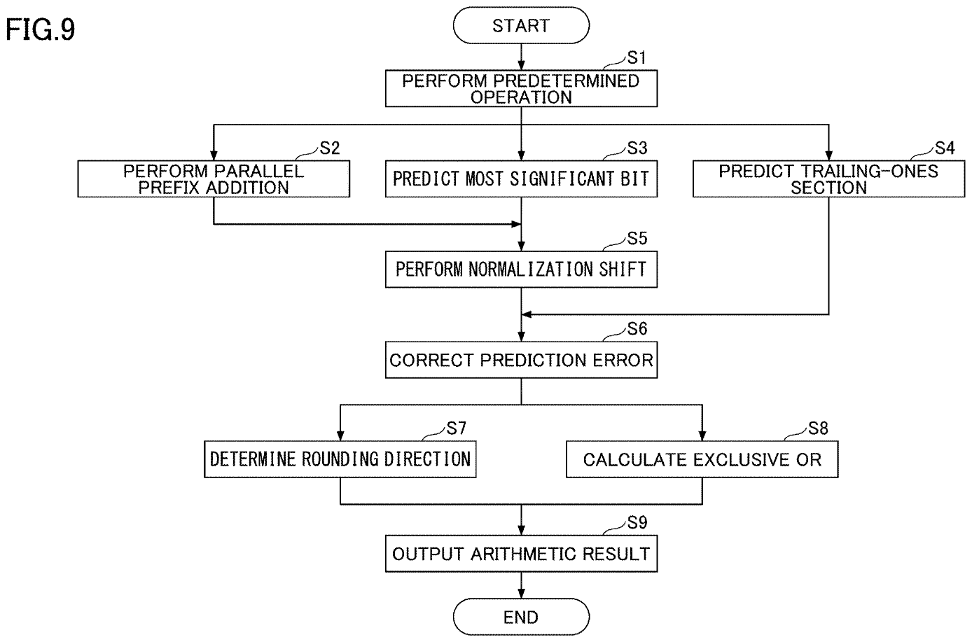

A flow of a computing method performed by the computing device 100 will be described with reference to FIG. 9. FIG. 9 is a flowchart illustrating an example of the computing method.

In step S1, the computing unit 110 of the computing device 100 performs the predetermined operation according to the instruction issued by the CPU of the host. For example, the computing circuit 130 of the computing unit 110 accepts inputs of multiplicand α, multiplier β, and addend γ, and computes α×β+γ. The computing circuit 130 inputs the bit sequences a and b representing the arithmetic result of α×β+γ to the rounding circuit 140.

The rounding circuit 140 of the computing unit 110 accepts inputs of the bit sequences a and b. The bit sequences a and b input to the rounding circuit 140 are input to the parallel prefix adder PPA, the leading zeros count anticipator LZA, and the trailing ones anticipator TOA, respectively.

In step S2, the parallel prefix adder PPA of the rounding circuit 140 computes the sum of the bit sequences a and b. With this, the bit sequence of the absolute value obtained by summing the bit sequences a and b is generated. The parallel prefix adder PPA inputs the bit sequence of the absolute value to the normalization shifter NS.

In step S3, the leading zeros count anticipator LZA of the rounding circuit 140 computes the prediction value L of the sum of the bit sequences a and b. The leading zeros count anticipator LZA predicts the position of the most significant bit of the arithmetic result based on the prediction value L. The leading zeros count anticipator LZA inputs the prediction result of the position of the most significant bit to the normalization shifter NS.

In step S4, the trailing ones anticipator TOA of the rounding circuit 140 computes a sum a+b of the bit sequence a and the bit sequence b and a sum a+b+2^{K} of the bit sequence a, the bit sequence b, and 2^{K}. The trailing ones anticipator TOA computes the XOR of a+b and a+b+2^{K}. With this, a bit sequence in which 1 is set in the trailing-ones section and 0 is set outside the section is generated. The trailing ones anticipator TOA may normalize the generated bit sequence by shifting, to the right, the generated bit sequence toward the end. The trailing ones anticipator TOA inputs the normalized bit sequence to the error corrector EC2 as the prediction result of the trailing-ones section.

In step S5, the normalization shifter NS of the rounding circuit 140 receives the bit sequence of the absolute value from the parallel prefix adder PPA. Additionally, the normalization shifter NS receives the prediction result of the position of the most significant bit from the leading zeros count anticipator LZA. The normalization shifter NS shifts the bit sequence of the absolute value to the left by using the number of leading zeros indicated in the prediction result as the shift amount. Accordingly, the bit sequence of the normalized absolute value is generated. The normalization shifter NS inputs the bit sequence of the normalized absolute value to the error corrector EC1.

In step S6, the error corrector EC1 of the rounding circuit 140 receives the bit sequence of the normalized absolute value from the normalization shifter NS. The error corrector EC1 corrects the prediction error by the leading zeros count anticipator LZA in the bit sequence of the normalized absolute value. The error corrector EC1 inputs the bit sequence of the absolute value after the error correction to the rounding direction determiner RDD, the selector circuit SEL1, and the XOR circuit XOR.

Additionally, the error corrector EC2 receives the prediction result of the trailing-ones section from the trailing ones anticipator TOA. The error corrector EC2 corrects the prediction error by the leading zeros count anticipator LZA in the prediction result of the trailing-ones section. The error corrector EC2 inputs the prediction result of the trailing-ones section after the error correction to the XOR circuit XOR.

In step S7, the rounding direction determiner RDD of the rounding circuit 140 accepts the bit sequence of the absolute value after the error correction. The rounding direction determiner RDD determines the rounding direction based on the bit sequence of the absolute value after the error correction. The rounding direction determiner RDD inputs the information indicating the rounding direction to the selector circuit SELL.

In step S8, the XOR circuit XOR of the rounding circuit 140 receives the bit sequence of the normalized absolute value from the error corrector EC. Additionally, the XOR circuit XOR receives the prediction result of the trailing-ones section after the error correction from the error corrector EC2. The XOR circuit XOR computes the XOR of the bit sequence of the absolute value and the prediction result of the trailing-ones section. The XOR circuit XOR inputs the bit sequence obtained by the XOR to the selector circuit SELL.

In step S9, the selector circuit SEL1 of the rounding circuit 140 receives the bit sequence of the absolute value after the error correction from the error corrector EC1. Additionally, the selector circuit SEL1 receives the XOR of the bit sequence of the absolute value and the prediction result of the trailing-ones section from the XOR circuit XOR. Furthermore, the selector circuit SEL1 receives the information indicating the rounding direction from the rounding direction determiner RDD.

The selector circuit SEL1 selects the bit sequence (the bit sequence of the absolute value) received from the error corrector EC1 or the bit sequence (the XOR of the bit sequence of the absolute value with the prediction result in the trailing-ones section) received from the XOR circuit XOR, based on the information indicating the rounding direction. The selector circuit SEL1 outputs the selected bit sequence. The rounding circuit 140 outputs the bit sequence output from the selector circuit SEL1 as the arithmetic result of the rounding.

The computing device 100 may perform in parallel a plurality of steps that can be performed in parallel among the steps illustrated in FIG. 9. For example, the computing device 100 may perform steps S2 to S4 in parallel. Additionally, for example, the computing device 100 may perform steps S7 and S8 in parallel.

When the trailing-ones section of the bit sequence representing the numerical value is known, the addition of one can be performed using the XOR operation. For example, a case where 4-bit values 0b1011 having the two consecutive trailing ones are incremented will be considered. When the XOR of the original value 0b1011 and a result 0b0110 obtained by shifting the original value to the left by one bit is computed, the value 0b 1101 is obtained. Then, when the least significant bit of the XOR result 0b1101 is inverted, the increment value 0b1100 is obtained. This computation indicates that the carry resulting from adding one to the original value propagates only to the bits in 0b0011 that are higher than the trailing-ones section.

The rounding circuit 140 includes the trailing ones anticipator TOA and the XOR circuit XOR, thereby performing rounding of the arithmetic result by the computing circuit 130 without adding one to the arithmetic result. In the related art, the processing of adding one occupies most of the delay time in the rounding. The computing device 100 does not perform the processing of adding one that occupies most of the delay time, thereby performing the rounding at high speed.

In the related art, techniques for reducing the circuit delay, such as the align shifter AS, the partial product generator PP, the Wallace tree circuit WT, the parallel prefix adder PPA, the leading zeros count anticipator LZA, the normalization shifter NS, and the error corrector EC have been proposed. The computing device 100 according to the present embodiment can be further increased in speed by using these techniques together.

In the related art, no technique has been proposed to shorten the circuit delay of the processing of adding one in rounding. This is partly because it has been considered that the processing of adding one cannot be started until at least the normalization shift is completed. Additionally, because the circuit delay of the processing of adding one has already been optimized, it is difficult to further reduce the circuit delay. Therefore, in the related art, it is difficult to avoid that the circuit delay of the processing of adding one occurs in series. The computing device 100 according to the present embodiment starts the processing equivalent to adding one before the normalization shift is completed. This allows the computing device 100 to perform the processing equivalent to adding one in parallel with the normalization shift and the like, thereby reducing the circuit delay.

### [Evaluation Result]

In order to evaluate the effectiveness of the present embodiment, a double-precision floating-point FMA circuit operating at a plurality of clock frequencies was synthesized, and its delay time and circuit area were analyzed. Additionally, for comparison with the embodiment, two comparative examples based on the related art were synthesized.

The embodiment corresponds to the computing unit 110 according to the embodiment. Comparative Example 1 is an FMA circuit implementing the circuit design disclosed in Reference 1. Reference 1 is for the purpose of saving the circuit area and not for the purpose of pursuing high-speed operation. Comparative Example 2 is an improved version of the circuit design disclosed in Reference 1 for the purpose of high-speed operation. Specifically, radix-16 Booth encoding is replaced with radix-4 Booth encoding. Furthermore, an error corrector and a rounding direction determiner are introduced into this FMA circuit by using the mask method disclosed in Reference 2.
[Reference 1]J. Sohn, D. K. Dean, E. Quintana, and W. S. Wong, “Enhanced floating-point multiply-add with full denormal support,” in 2023 IEEE 30th Symposium on Computer Arithmetic (ARITH), 2023, pp. 143-150.
[Reference 2]D. R. Lutz, “Optimized leading zero anticipators for faster fused multiply-adds,” in 2017 51st Asilomar Conference on Signals, Systems, and Computers, 2017, pp. 741-744.

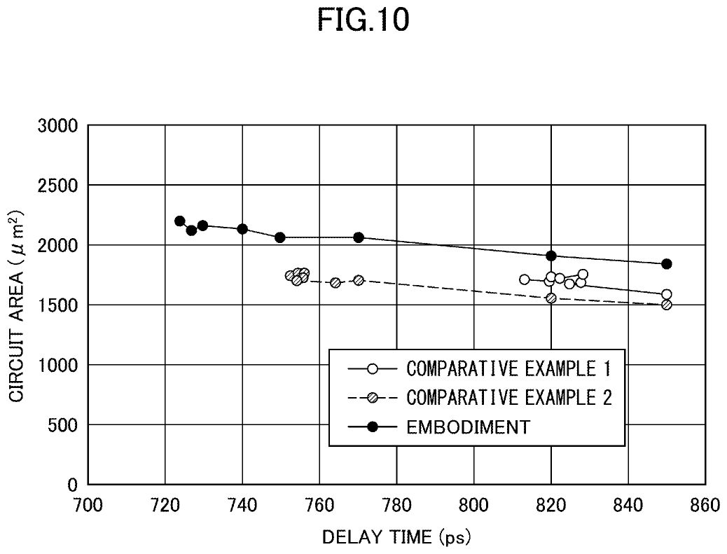

FIG. 10 is a graph illustrating an example of evaluation results. FIG. 10 illustrates evaluation results of the delay time and circuit area under various timing constraints. According to the evaluation results, the FMA circuit according to the embodiment can reduce the delay time by more than 30 picoseconds (ps) in comparison with Comparative Examples 1 and 2.

### Other Embodiments

In the present embodiment, the example in which the trailing ones anticipator TOA is a computing circuit different from the parallel prefix adder PPA, the leading zeros count anticipator LZA, or the like has been described. The trailing ones anticipator TOA may be configured such that a part of the circuit is shared with the parallel prefix adder PPA, the leading zeros count anticipator LZA, or the like.

In the present embodiment, the example in which the trailing ones anticipator TOA includes the bitonic sort circuit BS as the normalization shifter has been described. Instead of the bitonic sort circuit BS, the trailing ones anticipator TOA may include a suitable normalization shifter.

In the present embodiment, the example in which the computing device 100 includes the parallel prefix adder PPA or the Wallace tree circuit WT has been described. Instead of the parallel prefix adder PPA or the Wallace tree circuit WT, the computing device 100 may include a suitable adder.

The description of the present embodiment, the description of the drawings, the connection of arrows in the drawings, and the like are examples for ease of understanding, and the present disclosure is not limited thereto. Any computing device including a computing circuit having a function of the trailing ones anticipator TOA may be regarded as one embodiment of the present disclosure.

### SUMMARY

As is clear from the above description, the computing device 100 according to one embodiment of the present disclosure includes one or more computing circuits, and the one or more computing circuits perform a predetermined operation, predict a section of consecutive trailing ones of a bit sequence representing an arithmetic result of the predetermined operation, and perform rounding of the arithmetic result based on a result of predicting the section of the consecutive trailing ones.

The computing device 100 may compute the XOR of the arithmetic result with a second bit sequence having ones in at least the section, and output a result of the XOR as a result of rounding. The computing device 100 may normalize the second bit sequence and compute the XOR of the arithmetic result with the normalized second bit sequence. The normalization may be performed by a bitonic sort.

The computing device 100 may generate a third bit sequence in which only the least significant bit of the effective part of the arithmetic result is one, and predict the section of consecutive trailing ones based on the bit sequence and the sum of the bit sequence and the third bit sequence.

The computing device 100 may generate the third bit sequence by predicting the most significant bit of the effective part of the arithmetic result, shifting the bit sequence such that the most significant bit is shifted to the position of the least significant bit, and masking the bits lower than the least significant bit to zero in the shifted bit sequence.

The predetermined operation may include a floating-point operation. The floating point operation may include at least one of a multiply-add operation, an addition, or a multiplication. The predetermined operation may include an operation in a neural network.

The present disclosure can provide a computing device configured to perform rounding at high speed. A section of consecutive trailing ones of the arithmetic result affects the result of rounding. Additionally, the processing of adding one occupies most of the delay time in rounding. The computing device 100 according to the present embodiment predicts the section of consecutive trailing ones of the arithmetic result, thereby obtaining the result of rounding without adding one. Therefore, according to the present embodiment, a computing device configured to perform rounding at high speed can be provided.

### [Hardware Configuration of Computer]

Some or all of the computing method in the above-described embodiments may be configured by hardware or may be configured by information processing of software (program) executed by a central processing unit (CPU), a graphics processing unit (GPU), or the like. In the case where the embodiment is configured by the information processing of software, software for realizing at least some of the functions of the computing device 100 in the above-described embodiments may be stored in a non-transitory storage medium (a non-transitory computer-readable medium), such as a compact disc-read only memory (CD-ROM) or a universal serial bus (USB) memory, and a computer may read the software to perform the information processing of the software. Additionally, the software may be downloaded via a communication network. Furthermore, all or some of the processes of software may be implemented in a circuit, such as an application specific integrated circuit (ASIC) or a field programmable gate array (FPGA), and the information processing by the software may be executed by hardware.

The storage medium storing the software may be a removable medium, such as an optical disk, or a fixed storage medium, such as a hard disk or a memory. Additionally, the storage medium may be provided inside the computer (a main storage device, an auxiliary storage device, or the like) or may be provided outside the computer.

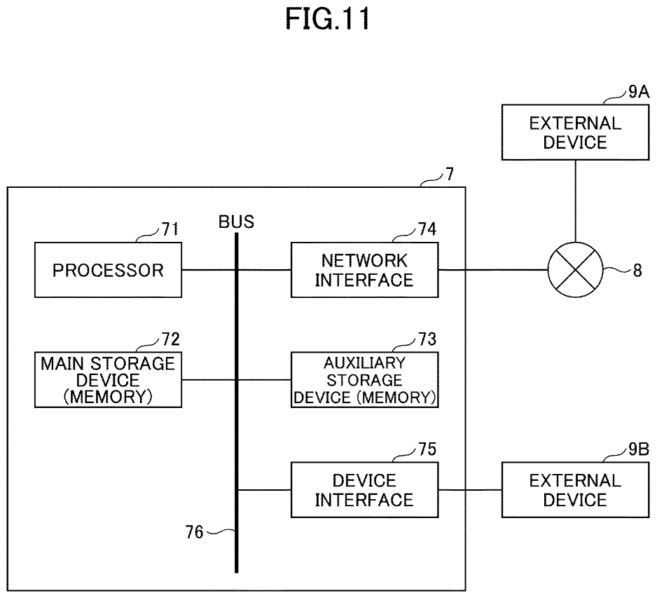

FIG. 11 is a block diagram illustrating an example of a hardware configuration of the computer on which the computing device 100 is mounted in the above-described embodiments. The information processing device may be implemented as a computer 7 including a processor 71, a main storage device 72 (memory), an auxiliary storage device 73 (memory), a network interface 74, and a device interface 75, which are connected via a bus 76, for example. The processor 71 may include the computing device 100. The processor 71 may include another processor, such as CPU or GPU, in addition to the computing device 100.

The computer 7 of FIG. 11 includes one of each component, but may include multiple units of the same components. Additionally, although FIG. 11 illustrates one computer 7, the software may be installed in multiple computers, and the multiple computers may execute the same or different partial processes of the software. In this case, the computers may be in a distributed computing form in which the computers communicate with each other via the network interface 74 or the like to perform the processes. That is, the computer on which the computing device 100 is mounted in the above-described embodiments may be configured as a system that realizes a function by one or more computers executing instructions stored in one or more storage devices. Additionally, the devices may be configured such that information transmitted from a terminal may be processed by one or more computers provided on a cloud, and the processing result may be transmitted to the terminal.

The various operations of the computer on which the computing device 100 is mounted in the above-described embodiments may be performed by parallel processing using one or more processors or using multiple computers connected via a network. Additionally, various operations may be distributed to multiple operation cores in the processor and performed by parallel processing. Additionally, some or all of the processes, means, and the like of the present disclosure may be implemented by at least one of a processor or a storage device provided on a cloud that can communicate with the computer 7 via a network. As described above, the computing device 100 in the above-described embodiments may be in a form of parallel computing by one or more computers.

The processor 71 may be an electronic circuit (a processing circuit, processing circuitry, a CPU, a GPU, an FPGA, an ASIC, or the like) that performs at least one of control or operations of a computer. Additionally, the processor 71 may be any of a general-purpose processor, a dedicated processing circuit designed to execute a specific operation, or a semiconductor device including both the general-purpose processor and the dedicated processing circuit. Additionally, the processor 71 may include an optical circuit or may include an arithmetic function based on quantum computing.

The processor 71 may perform arithmetic processing based on data or software input from each device or the like of the internal configuration of the computer 7, and may output an arithmetic result or a control signal to each device or the like. The processor 71 may control each component constituting the computer 7 by executing an operating system (OS), an application, or the like of the computer 7.

The computing device 100 in the above-described embodiments may be implemented by one or more processors 71. Here, the processor 71 may refer to one or more electronic circuits disposed on one chip, or may refer to one or more electronic circuits disposed on two or more chips or two or more devices. When multiple electronic circuits are used, the electronic circuits may communicate with each other by wire or wirelessly.

The main storage device 72 may store instructions executed by the processor 71, various data, and the like, and information stored in the main storage device 72 may be read by the processor 71. The auxiliary storage device 73 is a storage device other than the main storage device 72. Here, these storage devices indicate any electronic components capable of storing electronic information, and may be semiconductor memories. The semiconductor memory may be either a volatile memory or a nonvolatile memory. The storage device for storing various data and the like in the computing device 100 in the above-described embodiments may be realized by the main storage device 72 or the auxiliary storage device 73, or may be realized by a built-in memory built in the processor 71. For example, the storage devices in the above-described embodiments may be realized by the main storage device 72 or the auxiliary storage device 73.

When the computing device 100 in the above-described embodiments includes at least one storage device (memory) and at least one processor connected (coupled) to the at least one storage device, the at least one processor may be connected to one storage device. Additionally, at least one storage device may be connected to one processor. Additionally, a configuration in which at least one processor among the multiple processors is connected to at least one storage device among the multiple storage devices may be included. Additionally, this configuration may be realized by storage devices and the processors included in multiple computers. Furthermore, a configuration in which the storage device is integrated with the processor (for example, an L1 cache or a cache memory including an L2 cache) may be included.

The network interface 74 is an interface for connecting to a communication network 8 by wire or wirelessly. As the network interface 74, an appropriate interface, such as one conforming to an existing communication standard, may be used. The network interface 74 may exchange information with an external device 9A connected via the communication network 8. Here, the communication network 8 may be any one of a wide area network (WAN), a local area network (LAN), a personal area network (PAN), and the like, or a combination thereof, as long as information is exchanged between the computer 7 and the external device 9A. Examples of the WAN include the Internet and the like, and examples of the LAN include IEEE802.11, Ethernet (registered trademark), and the like. Examples of the PAN include Bluetooth (registered trademark), Near Field Communication (NFC), and the like.

The device interface 75 is an interface, such as a USB, that is directly connected to an external device 9B.

The external device 9A is a device connected to the computer 7 via a network. The external device 9B is a device directly connected to the computer 7.

The external device 9A or the external device 9B may be, for example, an input device. The input device is, for example, a device, such as a camera, a microphone, a motion capture device, various sensors, a keyboard, a mouse, a touch panel, or the like, and gives acquired information to the computer 7. Alternatively, the device may be a device including an input unit, a memory, and a processor, such as a personal computer, a tablet terminal, or a smartphone.

Additionally, the external device 9A or the external device 9B may be, for example, an output device. The output device may be, for example, a display device, such as a liquid crystal display (LCD) or an organic electro luminescence (EL) panel, or may be a speaker that outputs sound or the like. Alternatively, the device may be a device including an output unit, a memory, and a processor, such as a personal computer, a tablet terminal, or a smartphone.

Additionally, the external device 9A or the external device 9B may be a storage device (a memory). For example, the external device 9A may be a network storage or the like, and the external device 9B may be a storage, such as a hard disk drive (HDD).

Additionally, the external device 9A or the external device 9B may be a device having a function of a part of the components of the computing device 100 in the above-described embodiments. That is, the computer 7 may transmit a part or all of the processing result to the external device 9A or the external device 9B, or may receive a part or all of the processing result from the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “using data”, “based on data”, “according to data”, or “in accordance with data” (including similar expressions) is used, unless otherwise noted, a case in which the data itself is used and a case in which data obtained by processing the data (e.g., data obtained by adding noise, normalized data, a feature amount extracted from the data, and intermediate representation of the data) is used are included. If it is described that any result can be obtained “in response to data being input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states may be included. If it is described that “data is output” (including similar expressions), unless otherwise noted, a case in which the data itself is used as an output is included, and a case in which data obtained by processing the data in some way (e.g., data obtained by adding noise, normalized data, a feature amount extracted from the data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, and/or states, and that the advantage/result is not necessarily obtained by the configuration. The advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data. Additionally, a configuration in which some of the multiple storage devices store data may be included.

In the present specification (including the claims), the terms “first,” “second,” and the like are used as a method of merely distinguishing between two or more elements and are not necessarily intended to impose technical significance on their objects, in a temporal manner, in a spatial manner, in order, in quantity, or the like. Therefore, for example, a reference to first and second elements does not necessarily indicate that only two elements can be employed there, that the first element must precede the second element, that the first element must be present in order for the second element to be present, or the like.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in the embodiments described above, if numerical values or mathematical expressions are used for description, they are presented as an example and do not limit the scope of the present disclosure. Additionally, the order of respective operations in the embodiments is presented as an example and does not limit the scope of the present disclosure.

In the disclosed technique, aspects such as those described in the following clauses are conceivable.

### (Clause 1)

A computing device including one or more computing circuits, wherein the one or more computing circuits are configured to:
perform a predetermined operation;
predict a section of consecutive trailing ones of a first bit sequence representing an arithmetic result of the predetermined operation; and
round the arithmetic result based on a result of predicting the section of the consecutive trailing ones.

### (Clause 2)

The computing device as described in Clause 1,
wherein the one or more computing circuits compute an exclusive OR of a second bit sequence having ones in at least the section and the arithmetic result, and
wherein a result of the exclusive OR is output as a result of the rounding.

### (Clause 3)

The computing device as described in Clause 2, wherein the one or more computing circuits normalize the second bit sequence and compute an exclusive OR of the normalized second bit sequence and the arithmetic result.

### (Clause 4)

The computing device as described in Clause 3, wherein the normalization is performed by a bitonic sort.

### (Clause 5)

The computing device as described in any one of Clauses 1 to 4, wherein the one or more computing circuits generate a third bit sequence in which only a least significant bit of an effective part of the arithmetic result is one and predict the section of the consecutive trailing ones based on the first bit sequence and a sum of the first bit sequence and the third bit sequence.

### (Clause 6)

The arithmetic unit as described in Clause 5, wherein the one or more computing circuits generate the third bit sequence by predicting a most significant bit of the effective part of the arithmetic result, shifting the first bit sequence such that the most significant bit is at a position of the least significant bit, and masking bits lower than the least significant bit to zero in the shifted first bit sequence.

### (Clause 7)

The computing device as described in any one of Clauses 1 to 6, wherein the predetermined operation includes a floating-point operation.

### (Clause 8)

The computing device as described in Clause 7, wherein the floating-point operation includes at least one of a multiply-add operation, an addition, or a multiplication.

### (Clause 9)

The computing device as described in any one of Clauses 1 to 8, wherein the predetermined operation includes an operation in a neural network.

### (Clause 10)

A computing method including:
performing, by one or more computing circuits, a predetermined operation;
predicting, by the one or more computing circuits, a section of consecutive trailing ones of a first bit sequence representing an arithmetic result of the predetermined operation; and
rounding, by the one or more computing circuits, the arithmetic result based on a result of predicting the section of the consecutive trailing ones.

What is claimed is:

1. A computing device comprising one or more computing circuits, wherein the one or more computing circuits are configured to:
perform an arithmetic operation;
predict a section of consecutive trailing ones of a first bit sequence representing an arithmetic result of the arithmetic operation; and
round the arithmetic result based on the predicted section of the consecutive trailing ones.

2. The computing device as claimed in claim 1,
wherein the one or more computing circuits compute an exclusive OR of a second bit sequence having ones in at least a section corresponding to the section of the consecutive trailing ones of the first bit sequence and the arithmetic result, and
wherein a result of the exclusive OR is output as a result of the rounding.

3. The computing device as claimed in claim 2, wherein the one or more computing circuits normalize the second bit sequence and compute the exclusive OR of the normalized second bit sequence and the arithmetic result.

4. The computing device as claimed in claim 3, wherein the normalization is performed by a bitonic sort.

5. The computing device as claimed in claim 1, wherein the one or more computing circuits generate a third bit sequence in which only a least significant bit of an effective part of the arithmetic result is one and predict the section of the consecutive trailing ones based on the first bit sequence and a sum of the first bit sequence and the third bit sequence.

6. The computing device as claimed in claim 5, wherein the one or more computing circuits generate the third bit sequence by predicting a most significant bit of the effective part of the arithmetic result, shifting the first bit sequence such that the most significant bit is at a position of the least significant bit, and masking bits lower than the least significant bit to zero in the shifted first bit sequence.

7. The computing device as claimed in claim 1, wherein the arithmetic operation includes a floating-point operation.

8. The computing device as claimed in claim 7, wherein the floating-point operation includes at least one of a multiply-add operation, an addition, or a multiplication.

9. The computing device as claimed in claim 1, wherein the arithmetic operation includes an operation in a neural network.

10. The computing device as claimed in claim 1, wherein the one or more computing circuits correct a prediction error of the section of the consecutive trailing ones.

11. A computing method comprising:
performing, by one or more computing circuits, an arithmetic operation;
predicting, by the one or more computing circuits, a section of consecutive trailing ones of a first bit sequence representing an arithmetic result of the arithmetic operation; and
rounding, by the one or more computing circuits, the arithmetic result based on a result of predicting the section of the consecutive trailing ones.

12. The computing method as claimed in claim 11, further comprising:
computing, by the one or more computing circuits, an exclusive OR of a second bit sequence having ones in at least a section corresponding to the section of the consecutive trailing ones of the first bit sequence and the arithmetic result; and
outputting, by the one or more computing circuits, a result of the exclusive OR as a result of the rounding.

13. The computing method as claimed in claim 12, further comprising:
normalizing, by the one or more computing circuits, the second bit sequence; and
computing, by the one or more computing circuits, the exclusive OR of the normalized second bit sequence and the arithmetic result.

14. The computing method as claimed in claim 13, wherein the normalization is performed by a bitonic sort.

15. The computing method as claimed in claim 11, further comprising generating, by the one or more computing circuits, a third bit sequence in which only a least significant bit of an effective part of the arithmetic result is one, wherein
the predicting the section of the consecutive trailing ones is based on the first bit sequence and a sum of the first bit sequence and the third bit sequence.

16. The computing method as claimed in claim 15, wherein the generating the third bit sequence includes:
predicting, by the one or more computing circuits, a most significant bit of the effective part of the arithmetic result;
shifting, by the one or more computing circuits, the first bit sequence such that the most significant bit is at a position of the least significant bit; and
masking, by the one or more computing circuits, bits lower than the least significant bit to zero in the shifted first bit sequence.

17. The computing method as claimed in claim 11, wherein the arithmetic operation includes a floating-point operation.

18. The computing method as claimed in claim 17, wherein the floating-point operation includes at least one of a multiply-add operation, an addition, or a multiplication.

19. The computing method as claimed in claim 11, wherein the arithmetic operation includes an operation in a neural network.

20. The computing method as claimed in claim 11, further comprising correcting, by the one or more computing circuits, a prediction error of the section of the consecutive trailing ones.
